(19) United States
(12) Patent Application Publication
(10) Pub. No.: US 2012/0265703 A1
(43) Pub. Date: Oct. 18, 2012

(54) AD HOC SOCIAL NETWORKING

(75) Inventors: Arvind BASRA, Glen Ridge, NJ (US); Woo Beum LEE, Basking Ridge, NJ (US); Michelle FELT, Randolph, NJ (US)

(73) Assignees: VERIZON PATENT AND LICENSING INC., Basking Ridge, NJ (US); VERIZON NEW JERSEY, INC., Newark, NJ (US)

(21) Appl. No.: 13/086,100

(22) Filed: Apr. 13, 2011

(51) Int. Cl. G06Q 99/00; G06Q 10/00; G06F 15/16

(52) U.S. Cl. 705/319; 709/204; 705/321

(57) ABSTRACT

A system receives a set of criteria that identify characteristics desired in a user of a user device and that identify a location at which the user device is to be located; transmits the criteria to a server device; receives, from the server device, a list of user devices that are identified, by the server device, based on the criteria, where the list of user devices includes information relating to each user associated with the user devices; obtains video information of one of the users that are located at the location; selects a another user device, from the list of user devices, based on a determination that the video information matches information relating to a particular user, where the particular user is associated with the other user device; and communicates with the other user device, based on the selection of the other user device.

### BACKGROUND

Computing and communication devices are capable of performing an increasing variety of functions and tasks that continue to improve the user's experience. For example, computing and communication devices can run a variety of applications, can connect to a variety of wired and wireless networks to receive services, can perform point of sale transactions to purchase goods and/or services, and/or can download content, which can be stored and/or displayed on the computing and communicating devices. In one specific example, computing and communication devices can perform social networking by accessing websites that provide social networking services.

However, social networking websites may not always permit users of a communication and computing devices to perform social networking at a particular location or establishment. Additionally, social networking websites may not provide a service that enables users of computing and communication devices to locate and/or identify other users based on particular criteria identified by the users on an ad hoc basis.

### BRIEF DESCRIPTION OF THE DRAWINGS

FIG. 1 is a diagram of an example environment in which systems and/or methods described herein may be implemented;

FIG. 2 is a diagram of example components of one or more of the devices of FIG. 1;

FIG. 3 is a diagram of an example user device, as shown in FIG. 1;

FIG. 4 is a diagram of example components of the user device of FIG. 3;

FIG. 5 is a diagram of an example user set up user interface that is capable of being presented on the user device of FIG. 1;

FIG. 6 is a flow chart of an example process for registering a user device using an ad hoc social networking application;

FIGS. 7A-7C are diagrams of example target profile user interfaces, associated with the ad hoc social networking application, that are capable of being presented on the user device of FIG. 1; and

FIG. 8 is a flow chart of an example process for setting up a target profile on which an ad hoc social networking operation is performed;

FIG. 9 is a flow chart of an example process for performing an ad hoc social networking operation to identify a list of targets based on a target profile;

FIG. 10 is an example diagram of a target user interface according to an implementation described herein; and

FIG. 11. is a flow chart of an example process for selecting a target user as a result of an ad hoc social networking operation.

### DETAILED DESCRIPTION OF PREFERRED EMBODIMENTS

The following detailed description refers to the accompanying drawings. The same reference numbers in different drawings may identify the same or similar elements.

Systems and/or methods, described herein, may enable a user device to use an ad hoc social networking application (hereinafter referred to as an “ad hoc application”) to dynamically perform ad hoc social networking with another user device based on criteria established by the user. The term ad hoc social networking may include social networking between the user device and the other user device, where the other user device is dynamically selected based on ad hoc criteria established by the user (e.g., criteria inputted into the ad hoc application) and/or information obtained via the user device (such as, for example, a camera, a speaker, a blue tooth sensor, etc.). Ad hoc criteria may include a target profile that identifies information that is to be used to identify one or more users with which the user desires to communicate and/or perform social networking.

As described herein, the user device may download the ad hoc application and may use the ad hoc application to register the user device with an application server that enables ad hoc social networking to be performed. The registered user device may use the ad hoc application to establish one or more target profiles that identifies criteria that are to be used to identify users of other user devices with which to perform social networking. In one example, a target profile may include information associated with characteristics that the user desires in a companion (e.g., physical traits, gender, interests, hobbies, education level, etc.). In another example, the target profile may include information associated with a particular business establishment (e.g., a bar, a night club, etc.) that the user plans to attend to identify other user devices that are located or plan to be located at the business establishment. In yet another example, the target profile may include information associated with credentials (e.g., education, experience, skills, job history, etc.) that the user desires another user, of another user device, to possess to satisfy a job requirement.

The user device may transmit information associated with the target profile to an application server. The application server may use the information associated with the target profile to identify other users, of other user devices. The application server may identify the other users based on whether registration information, associated with the other user devices, match one or more criteria included within the information associated with the target profile. The application server may assign a respective score to each of the other user devices based on a degree to which the registration information, associated with each of the identified users, matches the information associated with the target profile. The application may transmit an ordered list, of the identified users, to the user device based on the assigned score. The ordered list of identified users may include registration information associated with each of the identified users on the list of identified users.

The user device may receive the list of identified users and may select, from the list, an identified user with which to perform social networking. The user may, for example, use the user device to communicate with another user device with which the identified user is associated (e.g., by calling, sending a text message, sending an email message, etc.).

In another example, the user may use the user device to select one of the identified users. For example, the user may use the user device (such as, for example, a camera associated with the user device) to scan an environment (e.g., a room within a night club or some other establishment) in which one or more identified users are located (e.g., based on criteria within the target profile). The user device may obtain information (e.g., audio, images, video, visual signatures, etc.) associated with one or more of the identified users. The ad hoc application may determine that registration information, associated with an identified user, matches a portion of the obtained information associated with one or more of the identified users (e.g., based on facial recognition techniques, voice signature techniques, etc.). The ad hoc application may select the identified user based on the determination that registration information matches the portion of the obtained information. The ad hoc application may display information (e.g., an image, a name, a phone number, job title, etc.) associated with the selected user to enable the user, of the user device, to determine whether to communicate with the selected user.

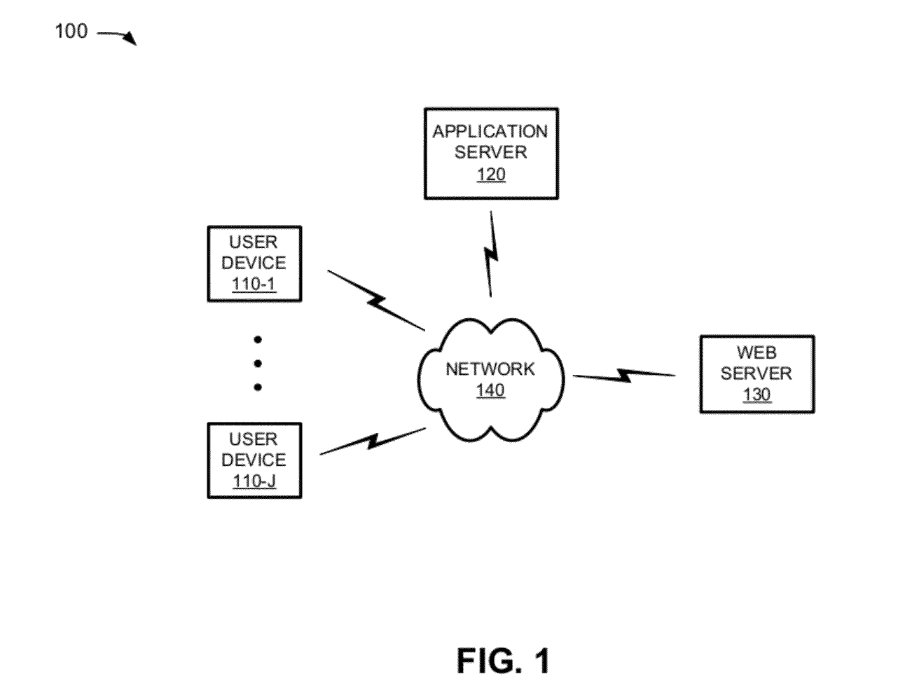

FIG. 1 is a diagram of an example environment 100 in which systems and/or methods described herein may be implemented. As shown in FIG. 1, environment 100 may include user devices 110-1 through 110-J (collectively referred to herein as “user devices,” and singularly as “user device”), an application server 120, a web server 130, and/or a client server 140 interconnected by a network 140. The number of devices and/or networks, illustrated in FIG. 1, is provided for explanatory purposes only. In practice, there may be additional networks and/or devices, fewer networks and/or devices, different networks and/or devices, or differently arranged networks and/or devices than illustrated in FIG. 1.

Also, in some implementations, one or more of the devices of environment 100 may perform one or more functions described as being performed by another one or more of the devices of environment 100. For example, application server 120, web server 130, and/or client server 140 may be integrated into a single device. Components of environment 100 may interconnect via wired connections, wireless connections, or a combination of wired and wireless connections.

User device 110 may include any computation or communication device, such as a wireless mobile communication device, that is capable of communicating with network 140. For example, user device 110 may include a radiotelephone, a personal communications system (PCS) terminal (e.g., such as a smart phone that may combine a cellular radiotelephone with data processing and data communications capabilities), a personal digital assistant (PDA) (e.g., that can include a radiotelephone, a pager, Internet/intranet access, etc.), a laptop computer, a tablet computer, a personal computer, a camera, a personal gaming system, or another type of computation or communication device. In one example implementation, user device 110 may include a global positioning satellite (GPS) component that communicates with a GPS constellation to obtain location information associated with user device 110.

In another example implementation, user device 110 may host an ad hoc application to perform ad hoc social networking operations. User device 110 may communicate with application server 120 to download and/or register the ad hoc application. The ad hoc application may be used to register user device 110. For example, user device 110 may download the ad hoc application and may begin executing the ad hoc application. The ad hoc application may cause a user set up user interface (UI) to be displayed on user device 110. The user set up UI may permit the user to enter registration information into fields associated with the set up UI. User device 110 may receive the registration via the user set up UI.

The ad hoc application may transmit the registration information to application server 120 in order to register user device 110. Application server 120 may receive the registration information and may store the registration information in a memory associated with application server 120. The ad hoc application may permit the user to set up a target profile to be used to identify another user, associated with another user device 110, with which to perform social networking. For example, the ad hoc application may receive information associated with a target profile from the user (e.g., via a target profile UI) and the ad hoc application may cause user device 110 to transmit the information associated with the target profile to the application server 120.

User device 110 may receive a list of users, associated with other user devices 110, that satisfy one or more criteria identified in the target profile and may display the list of users on user device 110. The list of users may include registration information associated with each of the users. The list of users may be sorted based on a score that corresponds to a level to which the users satisfied the target profile. User device 110 may receive, from the user, a selection of one of the users, from the list of users, and the ad hoc application may retrieve registration information associated with the selected user. User device 110 may display the retrieved registration information so that the user may communicate, via user device 110, with another user device 110 associated with the selected user.

In an example implementation, the user may attend a function at an establishment and may use user device 110 to collect information associated with one or more users on the list of users that are attending the function. User device 110 may collect the information associated with the users via a camera and/or speaker associated with user device 110. The ad hoc application may compare the information associated with the users to the registration information associated with each of the users on the list of users. The ad hoc application may select a particular user, from the list of users, based on a determination that all or a portion of the information associated with the users matches registration information associated with the particular user. The ad hoc application, in this example, may determine that image and/or video data of the particular user (e.g., obtained from the information associated with the users) matches other image data, of the particular user, that is included in the registration information. In another example, the ad hoc application may determine that audio data of the particular user (e.g., obtained from the information associated with the users) matches other audio data, of the particular user, that is included in the registration information.

Application server 120 may include one or more server devices, or other types of computation or communication devices, that gather, process, search, store, and/or provide information in a manner described herein. Application server 120 may communicate via network 140. Application server 120 may transmit an ad hoc application to user device 110 in response to a download request received from user device 110. Application server 120 may receive a registration request from user device 110 that includes registration information associated with user device 110. Application server 120 may store the registration information associated with user device 110 in a memory associated with application server 120.

Application server 120 may receive information associated with a target profile from user device 110 and may perform an operation to identify other user devices 110 that are to be associated with an ad hoc social network associated with user device 110. For example, application server 120 may use the information, associated with the target profile, to identify criteria that are to be used to identify the other user devices 110. Application server 120 may, in one example, determine that registration information, associated with one or more of the other user devices 110, matches one or more of the criteria identified from the information associated with the target profile. Application server 120 may store a list of identifiers associated with each of the one or more user devices 110.

Application server 120 may assign a score to each of the one or more other user devices 110 based on a level to which the registration information matches the criteria. For example, application server 120 may assign a first score to a first other user device 110 based a quantity of times that registration information, associated with the first other user device 110, matches the one or more criteria. In another example, application server 120 may assign a second score, which is less than the first score, when a quantity of times that registration information, associated with the second other user device 110, matches the one or more criteria is less than the quantity of times that registration information, associated with the first other user device 110, matches the one or more criteria.

In another example, application server 120 may identify a quantity of other user devices 110 (e.g., associated with friends of the user of user device 110) that are attending or plan to attend a function at a business (e.g., a club, a bar, etc.) that is identified in the target profile. The identification of the quantity of other user devices 110 may be based on location information associated with the other user devices 110 and/or based on monitoring communications, between the other user devices 110 and web server 130 (e.g., associated with one or more social networking websites). The monitoring of communications may enable application server 120 to identify which of the other user devices 110 plan to attend the function. In one example, a quantity of user devices 110 that plan to attend the function may be based on a quantity of user devices 110 that accept an electronic invitation associated with the function, via one or more social networking websites. In another example, application server 120 may determine a quantity of user devices 110 that plan to attend the function based on a respective calendar entry associated with each of the other user devices 110.

The monitoring of communications may enable application server 120 to obtain information associated with a sentiment with respect to users of the other user devices 110 that are attending or planning to attend the function. For example, a positive sentiment, with respect to the function, may be identified when a majority of other users describe the function using a quantity of positive terms, keywords, and/or phrases (e.g., “it'll be a great time,” “It's going to be exciting,” “I'm looking forward to going,” etc.) that is greater than a quantity of negative terms, keywords, and/or phrases (e.g., “it'll be a bad time,” “It's going to be boring,” “I'm not looking forward to it,” etc.). In a specific example, a positive sentiment, with respect to the function, may be identified when a quantity of user devices 110 transmit a quantity of positive indications (e.g., by selecting a button, such as a “likes this” button, on a social networking webpage, such as Facebook, etc.) that is greater than another quantity of negative indications that are transmitted by another quantity of user devices 110 (e.g., by selecting another button, such as a “doesn't like this” button, on a social networking web page).

A neutral sentiment, with respect to the function, may be identified when a majority of the other users describe the function using the quantity of positive terms, keywords, and/or phrases that are approximately equal to the quantity of negative terms or phrases. The neutral sentiment may, in another example, be identified when a quantity of positive indications is approximately equal to another quantity of negative indications. A negative sentiment, with respect to the function, may be identified when a majority of the other users describe the function using the quantity of positive terms and/or phrases that are less than the quantity of negative terms or phrases. The negative sentiment may, in another example, be identified when a quantity of positive indications is less than another quantity of negative indications.

Web server 130 may include one or more server devices, or other types of computation or communication devices, that gather, process, search, store, and/or provide information in a manner similar to that described herein. Web server 130 may communicate via network 140. In one example implementation, web server 130 may host a website associated with a social networking website (e.g., Facebook, Myspace, Twitter, Flickr, etc.), and/or a business (such as, for example, a bar, a night club, a restaurant, etc.). In one example, web server 130 may provide a social networking service to user devices 110 with which an account has been established. In this example, each user device 110 planning to attend the function may register, with web server 130, to attend the function, which may enable application server 120 to identify the quantity of user devices 110 planning to attend the function.

Network 140 may include one or more wired and/or wireless networks. For example, network 140 may include a cellular network, a public land mobile network (PLMN), a second generation (2G) network, a third generation (3G) network, a fourth generation (4G) network (e.g., a long term evolution (LTE) network), a fifth generation (5G) network, and/or another network. Additionally, or alternatively, network 140 may include a wide area network (WAN), a metropolitan network (MAN), a telephone network (e.g., the Public Switched Telephone Network (PSTN)), an ad hoc network, an intranet, the Internet, a fiber optic-based network, and/or a combination of these or other types of networks.

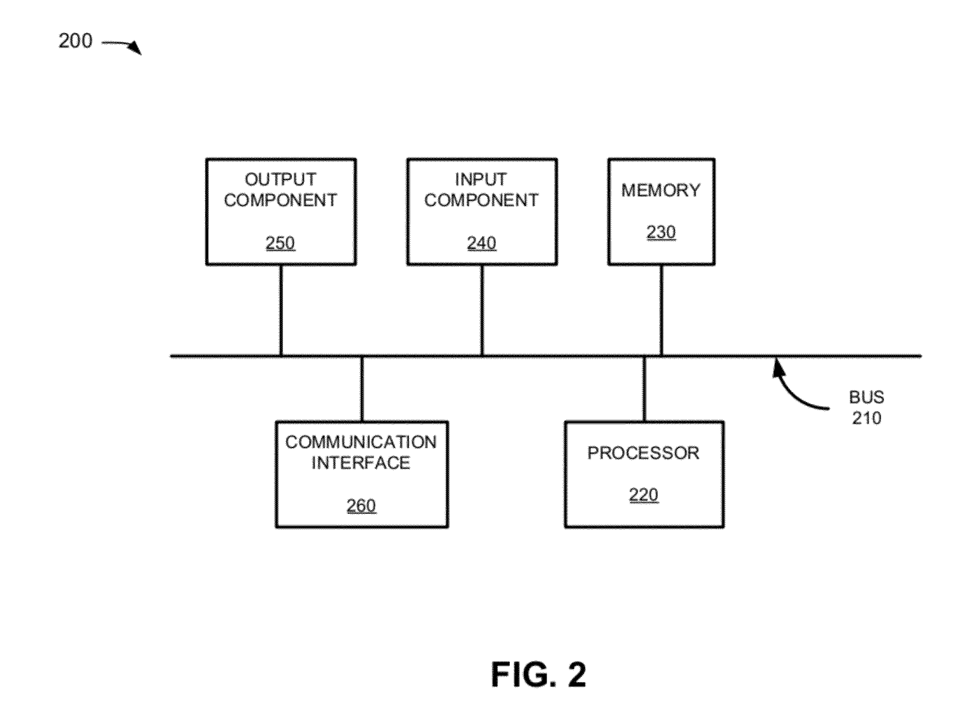

FIG. 2 is a diagram of example components of a device 200 that may correspond to application server 120 and/or web server 130. Device 200 may include a bus 210, a processor 220, a memory 230, an input component 240, an output component 250, and a communication interface 260. Although FIG. 2 shows example components of device 200, in other implementations, device 200 may include fewer components, additional components, different components, or differently arranged components than depicted in FIG. 2. Additionally, or alternatively, in other implementations, one or more components of device 200 may perform one or more tasks described as being performed by one or more other components of device 200.

Bus 210 may include a path that permits communication among the components of device 200. Processor 220 may include a processor, microprocessor, or processing logic that may interpret and execute instructions. Memory 230 may include any type of dynamic storage device that may store information and instructions for execution by processor 220, and/or any type of non-volatile storage device that may store information for use by processor 220.

Input component 240 may include a mechanism that permits an operator to input information to device 200, such as a keyboard, a keypad, a button, a switch, etc. Output component 250 may include a mechanism that outputs information to the operator, such as a display, a speaker, one or more light emitting diodes (LEDs), etc. Communication interface 260 may include any transceiver-like mechanism that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.) or a combination of wireless and wired communications. For example, communication interface 260 may include mechanisms for communicating with another device or system via a network, such as network 140.

As will be described in detail below, device 200 may perform operations relating to ad hoc social networking. Device 200 may perform these operations in response to processor 220 executing software instructions contained in a computer-readable medium, such as memory 230. A computer-readable medium may be defined as a non-transitory memory device. A memory device may include space within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of or in combination with software instructions to implement processes described herein. Thus, implementations described herein are not limited to any specific combination of hardware circuitry and software.

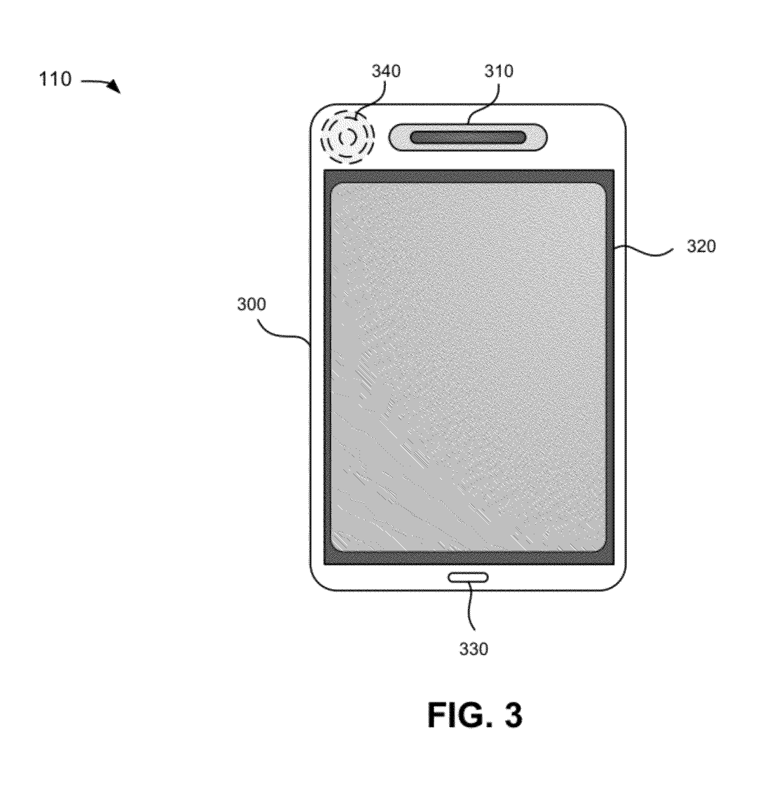

FIG. 3 is a diagram of an example user device 110. As shown in FIG. 3, user device 110 may include a housing 300, a speaker 310, a display 320, a microphone 330, and/or a camera 340. Housing 300 may include a chassis via which some or all of the components of user device 110 are mechanically secured and/or covered. Speaker 310 may include a component to receive input electrical signals from user device 110 and transmit audio output signals, which communicate audible information to a user of user device 110.

Display 320 may include a component to receive input electrical signals and present a visual output in the form of text, images, videos and/or combinations of text, images, and/or videos which communicate visual information to the user of user device 110. In one implementation, display 320 may display text input into user device 110, text, images, and/or video received from another device, and/or information regarding incoming or outgoing calls or text messages, emails, media, games, phone books, address books, the current time, etc.

Display 320 may be a touch screen that presents one or more images that corresponds to control buttons. The one or more images may accept, as input, mechanical pressure from the user (e.g., when the user presses or touches an image corresponding to a control button or combinations of control buttons) and display 320 may send electrical signals to processor 220 that may cause user device 110 to perform one or more operations. For example, the control buttons may be used to cause user device 110 to transmit information. Display 320 may present one or more other images associated with a keypad that, in one example, corresponds to a standard telephone keypad or another arrangement of keys.

Microphone 330 may include a component to receive audible information from the user and send, as output, an electrical signal that may be stored by user device 110, transmitted to another user device, or cause the device to perform one or more operations. Camera 340 may be provided on a front or back side of user device 110, and may include a component to receive, as input, analog optical signals and send, as output, a digital image or video that can be, for example, viewed on display 320, stored in the memory of user device 110, discarded and/or transmitted to another user device 110.

Although FIG. 3 depicts example components of user device 110, in other implementations, user device 110 may include fewer components, additional components, different components, or differently arranged components than illustrated in FIG. 3. For example, user device 110 may include a keyboard, a keypad, and/or other input components. In still other implementations, one or more components of user device 110 may perform one or more tasks described as being performed by one or more other components of user device 110.

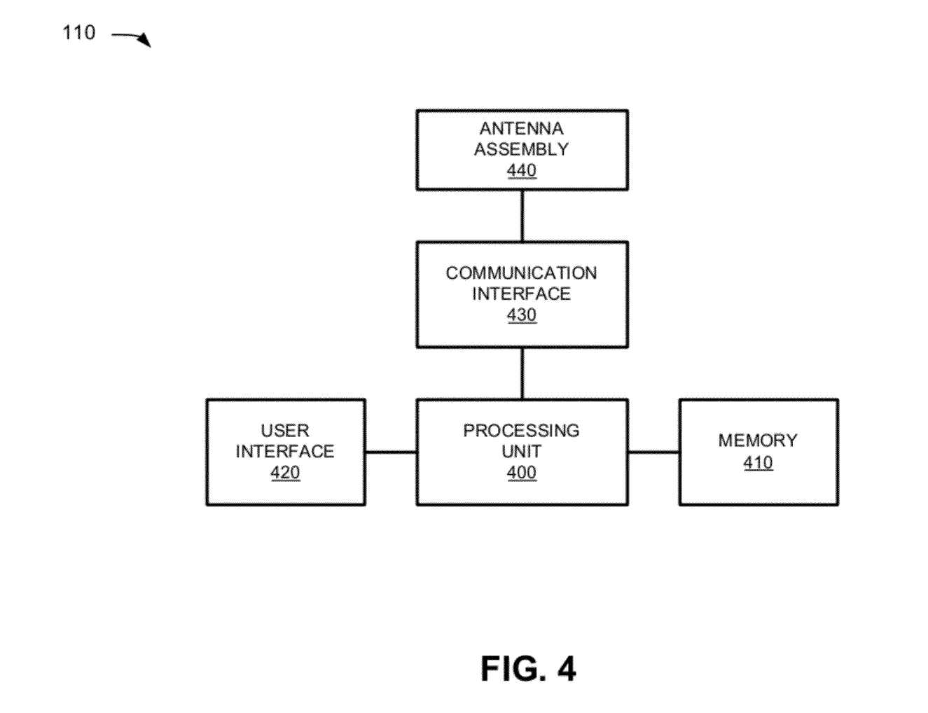

FIG. 4 is a diagram of example components of user device 110. As shown in FIG. 4, user device 110 may include a processing unit 400, a memory 410, a user interface 420, a communication interface 430, and/or an antenna assembly 440. Although FIG. 4 shows example components of user device 110, in other implementations, user device 110 may include fewer components, additional components, different components, or differently arranged components than depicted in FIG. 4. In still other implementations, one or more components of user device 110 may perform one or more tasks described as being performed by one or more other components of user device 110.

Processing unit 400 may include a processor, a microprocessor, an application-specific integrated circuit (ASIC), a field-programmable gate array (FPGA), or the like. Processing unit 400 may control operation of user device 110 and its components. In one implementation, processing unit 400 may control operation of components of user device 110 in a manner similar to that described herein. Memory 410 may include a RAM, a ROM, and/or another type of memory to store data and/or instructions that may be used by processing unit 400.

User interface 420 may include mechanisms for inputting information to user device 110 and/or for outputting information from user device 110. Examples of input and output mechanisms might include buttons (e.g., control buttons, keys of keypad, a keyboard, a joystick, etc.); a touch screen interface to permit data and control commands to be input into user device 110 via display 320; a biometric device to receive fingerprint scans, retinal scans, facial signatures, etc.; a speaker (e.g., speaker 310) to receive electrical signals and output audio signals; a microphone (e.g., microphone 330) to receive audio signals and output electrical signals; a display (e.g., display 320) to output visual information (e.g., user interfaces, web pages, etc.); a vibrator to cause user device 110 to vibrate; and/or a camera (e.g., camera 340) to receive video and/or images.

Communication interface 430 may include, for example, a transmitter that may convert baseband signals from processing unit 400 to RF signals and/or a receiver that may convert RF signals to baseband signals. Alternatively, communication interface 430 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications. Communication interface 430 may connect to antenna assembly 440 for transmission and/or reception of the RF signals.

Antenna assembly 440 may include one or more antennas to transmit and/or receive RF signals over the air. Antenna assembly 440 may, for example, receive RF signals from communication interface 430 and transmit them over the air, and receive RF signals over the air and provide them to communication interface 430. In one implementation, for example, communication interface 430 may communicate with a network and/or devices connected to a network (e.g., network 140, etc.).

As described in detail below, user device 110 may perform certain operations described herein in response to processing unit 400 executing software instructions of an application contained in a computer-readable medium, such as memory 410. The software instructions may be read into memory 410 from another computer-readable medium or from another device via communication interface 430. The software instructions contained in memory 410 may cause processing unit 400 to perform processes that will be described later. Alternatively, hardwired circuitry may be used in place of or in combination with software instructions to implement processes described herein. Thus, implementations described herein are not limited to any specific combination of hardware circuitry and software.

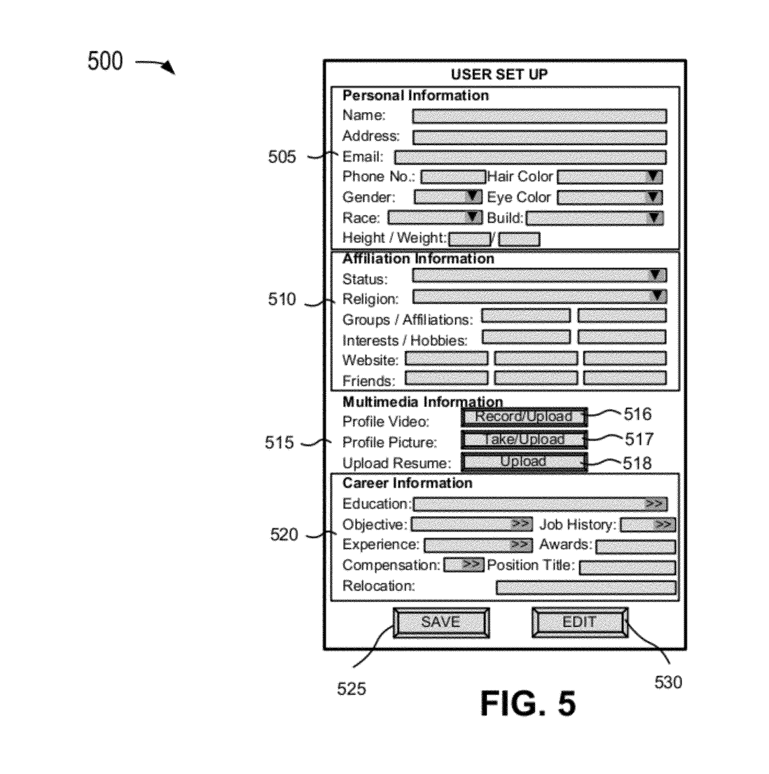

FIG. 5 is a diagram of an example user set up user interface (UI) 500 (hereinafter referred to as “set up UI 500”) that is capable of being presented on display 320 of user device 110. Set up UI 500 may be presented on user device 110, by an ad hoc application when performing a registration operation. As shown in FIG. 5, set up UI 500 may include a collection of fields and/or buttons, such as a personal information field 505, an affiliation information field 510, a multimedia information field 515, a record/upload button 516, a take/upload button 517, a resume upload button 518, a career information field 520, a save button 525, and an edit button 530. Set up UI 500 includes fields and/or buttons 505-530 for explanatory purposes. In practice, set up UI 500 may include additional fields and/or buttons, fewer fields and/or buttons, different fields and/or buttons, and/or differently arranged fields and/or buttons than are described with respect to set up UI 500.

Personal information field 505 may permit a user, of user device 110, to enter personal information associated with the user. For example, the user may enter a name (e.g., a first name, last name, an identifier, etc.) associated with the user, an address (e.g., a home address, a business address, etc.) associated with the user, an email address associated with the user, and/or a telephone number (phone no.) (e.g., a mobile directory number (MDN), a landline number (LDN), etc.) associated with user device 110. In another example, personal information field 505 may permit the user to enter and/or select (e.g., using a pull down menu as indicated by down arrow “▾”) information associated with a hair color of the user, an eye color of the user, a gender of the user, or a race associated with the user. In yet another example, personal information field 505 may permit the user to enter and/or select an indication of a build (e.g., slim, athletic build, tall, short, etc.) associated with the user and/or information regarding a height and/or weight associated with the user.

Affiliation information field 510 may permit the user to enter and/or select affiliation information, such as, for example, information regarding a status (e.g., married, divorced, single, etc.) of the user, information regarding a religion practiced by the user, and/or information associated with groups and/or affiliations (e.g., The Rotary Club, a political party, etc.) with which the user is associated. Affiliation information field 510 may also, or alternatively, permit the user to enter information associated with interests and/or hobbies (e.g., sailing, music, rock climbing, etc.) of the user, universal resource locators (URLs) associated with websites accessed by the user most often, information associated with other user devices 110 (e.g., a MDN, email address, etc.), that corresponds to friends, with which user device 110 communicates most often, etc.

Multimedia information field 515 may permit the user to enter and/or upload multimedia information associated with the user, such as a profile video, an image, a resume and/or other information associated with the user. For example, the user may select record/upload button 516 to upload and/or record a profile video (e.g., using user device 110) associated with the user. In another example, the user may select take and/or upload button 517 to upload and/or take a picture (e.g., using user device 110) of the user. In yet another example, the user may select upload button 518 to upload a resume and/or another document associated with the user.

Career information 520 may permit the user to enter career information, such as information associated with an education (e.g., college and/or university attended, degree obtained, year graduated, etc.) obtained by the user, a description of a career objective, information associated with a job history of the user, information associated with experience possessed by the user (e.g., years, months, days, etc.), etc. The user may select an expand button (e.g., shown as “>>”) to cause a new career information UI to open and/or career information field 520 to expand when information being entered exceeds available space in a particular field. Career information field 520 may also, or alternatively, permit the user to enter information associated with awards received, amount of compensation being sought in a target job, a position title associated with the target job, and/or information associated with a geographic area and/or region that the user desires or does not desire to relocate. The user may save the registration information by selecting save button 525 and/or may edit registration information by selecting edit button 530.

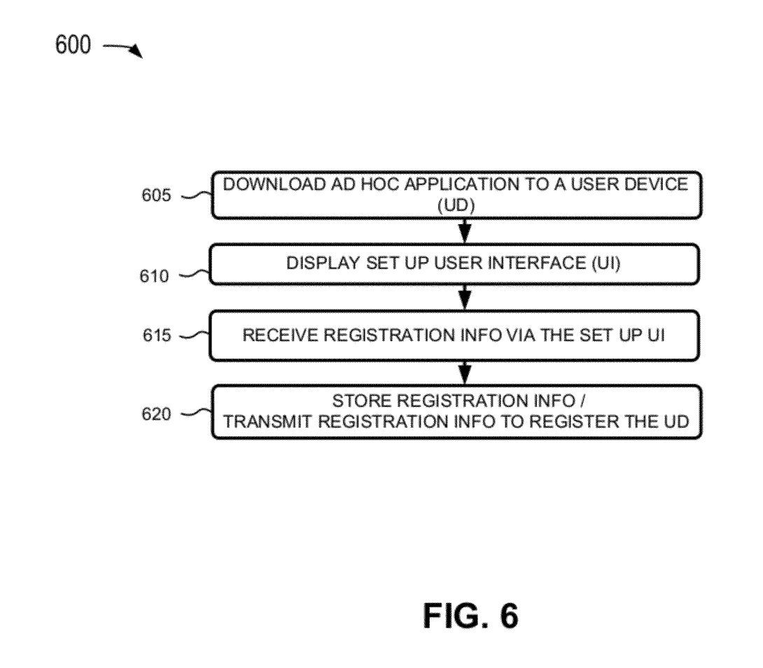

FIG. 6 is a flow chart of an example process 600 for registering user device 110 with application server 120. In one example implementation, process 600 may be performed by user device 110. In another example implementation, some or all of process 600 may be performed by a device or a collection of devices separate from, or in combination with, user device 110.

As shown in FIG. 6, process 600 may include downloading an ad hoc application to a user device (block 605) and displaying a set up UI (block 610). For example, user device 110 may, in response to a request from a user, of user device 110, communicate with application server 120 to download an ad hoc application. Application server 120 may receive the request and may transmit the ad hoc application to user device 110.

User device 110 may receive the ad hoc application and may store and/or install the application in a memory associated with user device 110. The ad hoc application may cause user device 110 to present a set up UI (e.g., set up UI 500 of FIG. 5) for display on user device 110.

As also shown in FIG. 6, process 600 may include receiving registration information via the set up UI (block 615). For example, the user may enter registration information, associated with the user, into the set up UI (e.g., set up UI 500 of FIG. 5). The registration information may, in a manner similar to that described above with respect to FIG. 5, include personal information associated with the user, affiliation information associated with the user, multimedia information associated with the user, and/or career information associated with the user. User device 110 may receive the registration information, via the set up UI.

As further shown in FIG. 6, process 600 may include storing the registration information and transmitting the registration information to register the user device (block 625). For example, the ad hoc application may process the registration by encrypting, scrambling, encoding, and/or otherwise converting the registration information into a format that cannot be accessed, copied, and/or edited by another user or used by any other application other than the ad hoc application. Alternatively, and/or additionally, the ad hoc application may store the processed registration information in a memory associated with user device 110. The ad hoc application may cause user device 110 to transmit the registration information to application server 120 to register user device 110 and/or the ad hoc application installed on user device 110. Application server 120 may receive the registration information and may store the registration information in a memory associated with application server 120.

Additionally, or alternatively, application server 120 may communicate with user device 110 to obtain information associated with user device 110 (e.g., a device identifier, a device address, etc.) and/or information associated with the user (e.g., a name, a username, a password, a PIN, an address, etc.). Application server 120 may, for example, use the information associated with user device 110 and/or the information associated with the user to register user device 110 and/or the ad hoc application. Application server 120 may generate confirmation information (e.g., a confirmation number, etc.) and may transmit the confirmation information to user device 110. The registration may permit user device 110 to download, at a later point in time, updates to the ad hoc application and/or to access services associated with performing an ad hoc social networking operation.

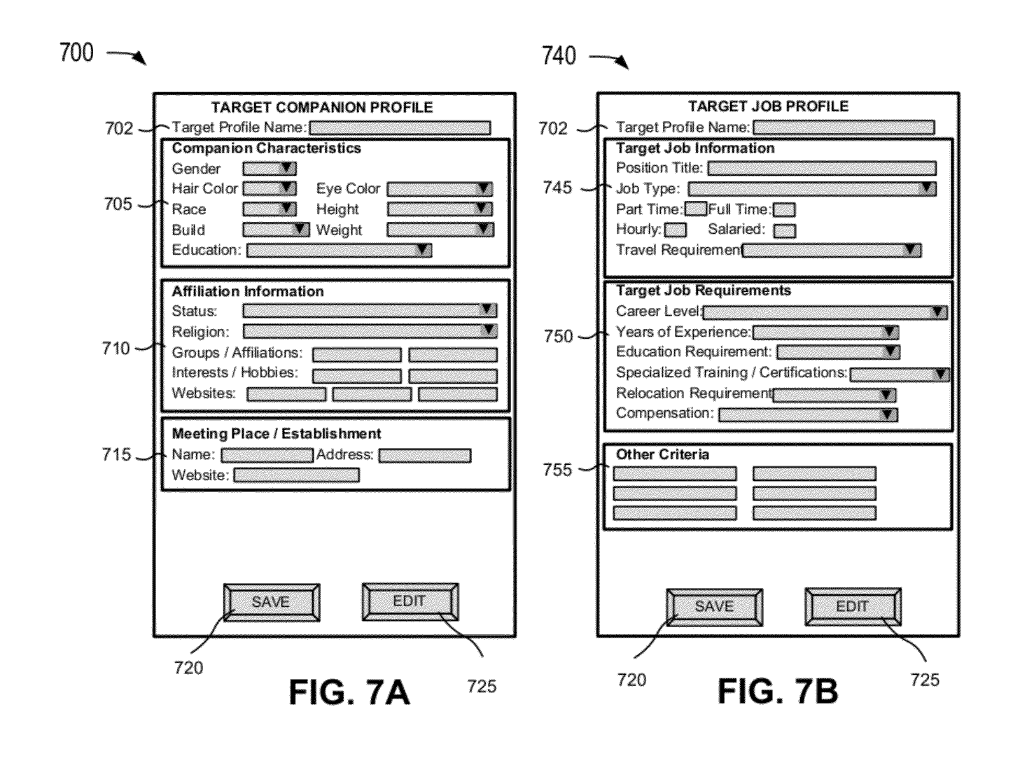

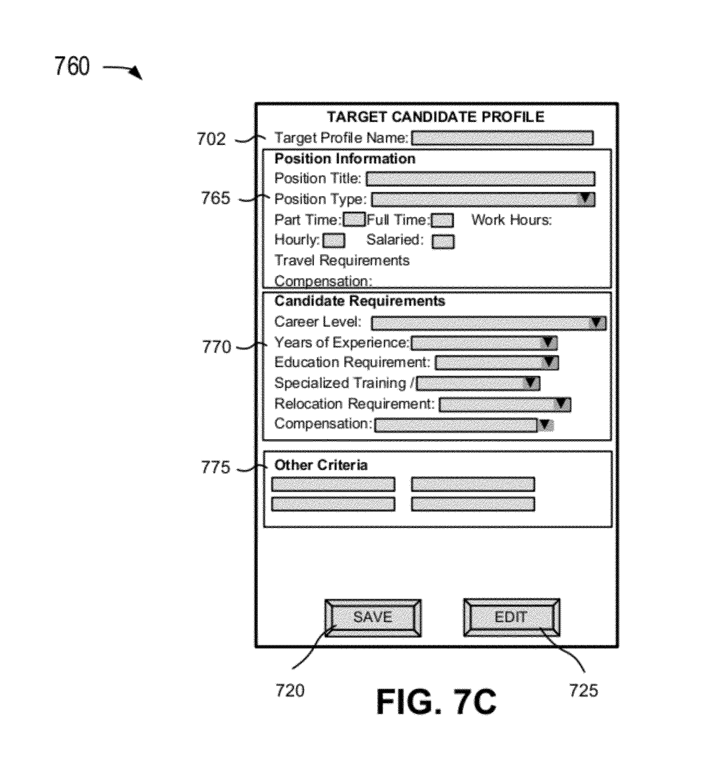

FIGS. 7A-7C are diagrams of example target profile user interfaces (UIs) that are capable of being presented on user device 110. The target profile UIs may be presented on user device 110, by an ad hoc application when performing an ad hoc social networking operation. As shown in FIG. 7A, a target companion profile UI 700 may include a collection of fields and/or buttons, such as a target profile name field 702, a companion characteristics field 705, an affiliation information field 710, a meeting place/establishment field 715, a save button 720, and an edit button 725.

Target profile name field 702 may permit a user, of user device 110, to enter information associated with a target companion profile (such as, for example, a target companion profile name, identifier, etc.). Companion characteristics field 705 may permit the user to enter companion characteristics information that the user desires that a companion (e.g., another user of another user device 110) possess. For example, the user may enter and/or select information associated with a gender of the companion, information associated with a hair color of the companion, an indication of an eye color of the companion, and/or an indication of a race of the companion. In another example, companion characteristics field 705 may permit the user to enter and/or select an indication of a build (e.g., slim, athletic build, tall, short, etc.) associated with the companion, and/or an indication of a height and/or weight associated with the companion. In yet another example, companion characteristics field 705 may permit the user to enter and/or select information associated with an education of the companion.

Affiliation information field 710 may permit the user to enter and/or select affiliation information associated with the companion, such as, for example, an indication regarding a status (e.g., married, divorced, single, etc.) of the companion, an indication regarding a religion practiced by the companion, and/or information associated with groups and/or affiliations with which the companion is associated. Affiliation information field 710 may also, or alternatively, permit the user to enter information associated with interests and/or hobbies of the companion, universal resource locators (URLs) associated with websites accessed by the companion most often, etc.

Meeting place/establishment field 715 may permit the user to enter information associated with a location at which the user desires to meet a friend or companion. For example, the user may enter a name or some other identifier associated with a business or an establishment (e.g., a night club, a restaurant, coffee shop, etc.), an address and/or location of the business or establishment, and/or information associated with a website that corresponds to the business or establishment.

As shown in FIG. 7B, a target job profile UI 740 may include a collection of fields and/or buttons that are included in FIG. 7A, such as target profile name field 702, save button 720, and/or edit button 725. Target job profile UI 740 may also include a collection of fields, such as a target job information field 745, a target job requirements field 750, and/or an other criteria field 755.

Target job information field 745 may permit the user to enter and/or select a position title associated with a target job, information associated with a job type (e.g., white collar, blue collar, career field, etc.), an indication of whether the target job is to be a part time job or a full time job, an indication of whether the target job is to be paid on an hourly basis or a salaried basis, and/or information associated with any travel requirements associated with the target job.

Target job requirements field 750 may permit the user to enter and/or select information associated with a career level (e.g., entry level, mid-level, management level, executive level, etc.) associated with the target job, an indication of years of experience required to qualify for the target job, and/or information associated with educational requirements associated with the target job. Target job requirements field 750 may also, or alternatively, permit the user to enter and/or select information associated with specialized training and/or certifications required to qualify for the target job, information associated with relocation requirements of the target job (e.g., an indication that the job requires relocation to a particular location, city, and/or region to perform the job, etc.), and/or information associated with compensation associated with the target job (e.g., base salary, bonuses, benefits, etc.).

Other criteria field 755 may permit the user to enter other information, such as information associated with desired work hours, any travel restrictions, any special accommodations, and/or keywords to be used to identify a target job.

As shown in FIG. 7C, a target candidate profile UI 760 may include a collection of fields and/or buttons that are included in FIG. 7A, such as target profile name field 702, save button 720, and/or edit button 725. Target candidate profile UI 760 may also include a collection of fields, such as a position information field 765, a candidate requirements field 770, and/or an other criteria field 775.

Position information field 765 may permit the user to enter and/or select a position title associated with a position to which the user desires to identify a candidate (e.g., another user of another user device 110). Position information field 765 may also, or alternatively, permit the user to enter and/or select information associated with a type of position to be filled (e.g., white collar, blue collar, career field, etc.), an indication of whether the position is to be a part time position or a full time position, an indication of whether the position is to be paid on an hourly basis or a salaried basis, and/or information associated with any travel requirements associated with the position.

Candidate requirements field 770 may permit the user to enter and/or select information associated with a career level (e.g., entry level, mid-level, management level, executive level, etc.) associated with the position, an indication of years of experience required to qualify for the position, and/or information associated with educational requirements associated with the position. Candidate requirements field 770 may also, or alternatively, permit the user to enter and/or select information associated with specialized training and/or certifications required to qualify for the position, information associated with relocation requirements of the position (e.g., an indication that the job requires the candidate to relocate to a particular location, city, and/or region, etc.), and/or information associated with compensation associated with the position (e.g., base salary, bonuses, benefits, etc.).

Other criteria field 775 may permit the user to enter other information, such as information associated with required work hours, special accommodations associated with the position, and/or keywords to be used to advertise the position.

The target profile UIs of FIGS. 7A-7C, respectively, include a number of fields and/or buttons for explanatory purposes. In practice, the target profile UIs may include additional fields and/or buttons, fewer fields and/or buttons, different fields and/or buttons, and/or differently arranged fields and/or buttons than are described with respect to the target profile UIs. Additionally, in other implementations, target profiles other than the target profile UIs may be generated by the ad hoc application. In one example implementation, the ad hoc application may permit a user to generate a target profile by entering one or more key words into a generic target profile UI. The ad hoc application UI may use the key words as criteria to identify another user device 110 with which to establish an ad hoc social networking session.

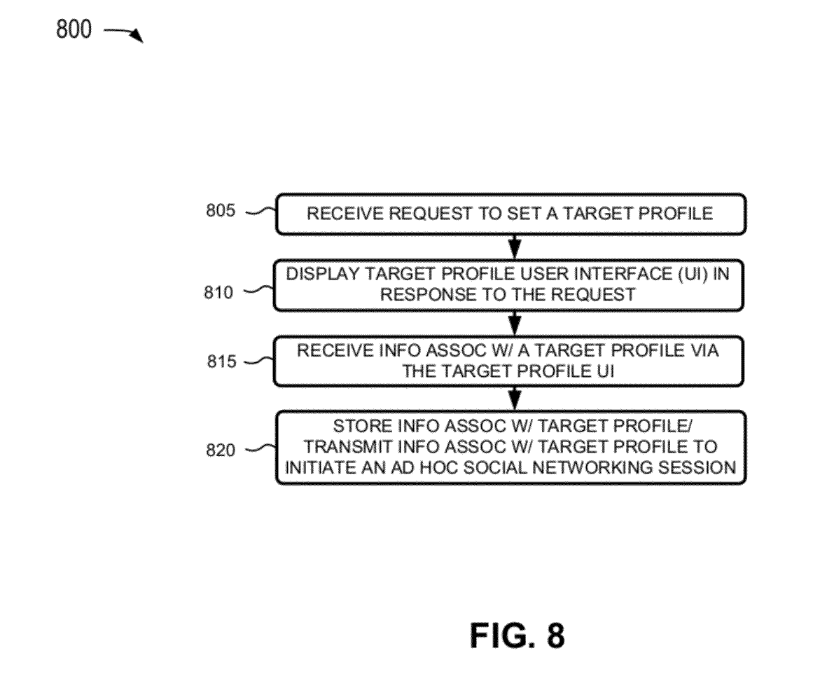

FIG. 8 is a flow chart of example process 800 for setting up a target profile, associated with user device 110, on which an ad hoc social networking session may be established. In one example implementation, process 800 may be performed by user device 110. In another example implementation, some or all of process 800 may be performed by a device or collection of devices separate from, or in combination with, user device 110.

As shown in FIG. 8, process 800 may include receiving a request to set up a target profile (block 805) and displaying a target profile UI in response to the request (block 810). For example, an ad hoc application may, in response to a request from a user of user device 110 to set up a target profile, cause a profile menu to be displayed on user device 110. The profile menu may include a list of target profiles that permit the user to select a target profile on which to base an ad hoc social networking session. The list of target profiles may correspond to a target companion profile (e.g., in a manner similar to that described above in FIG. 7A), a target job profile (e.g., in a manner similar to that described above in FIG. 7B), a target candidate profile (e.g., in a manner similar to that described above in FIG. 7C) and/or other target profiles (e.g., a generic profile, etc.). The ad hoc application may receive a selection of a target profile, via the menu profile UI, and may cause user device 110 to display a target profile UI that corresponds to the selection of the target profile.

As also shown in FIG. 8, process 800 may include receiving, via the target profile UI, information associated with a target profile (block 815). For example, a user, of user device 110, may enter information associated with a target profile into the target profile UI and user device 110 may receive, via the target profile UI, the information associated with the target profile. In one example, the information associated with target profile may include information associated with a target companion, in a manner similar to that described above with respect to FIG. 7A. In another example, the information associated with target profile may include information associated with a target job, in a manner similar to that described above with respect to FIG. 7B. In yet another example, the information associated with target profile may include information associated with a target candidate, in a manner similar to that described above with respect to FIG. 7C. In still another example, the information associated with target profile may include one or more key words that are to be used by the ad hoc application to establish the ad hoc social networking session.

As further shown in FIG. 8, process 800 may include storing information associated with a target profile and transmitting the information associated with the target profile to initiate an ad hoc social networking session (block 820). The ad hoc application may store the information associated with the target profile in a memory associated with user device 110. The ad hoc application may send, to application server 120, a request to establish a social networking session associated with user device 110. The request may include all or a portion of the information associated with the target profile.

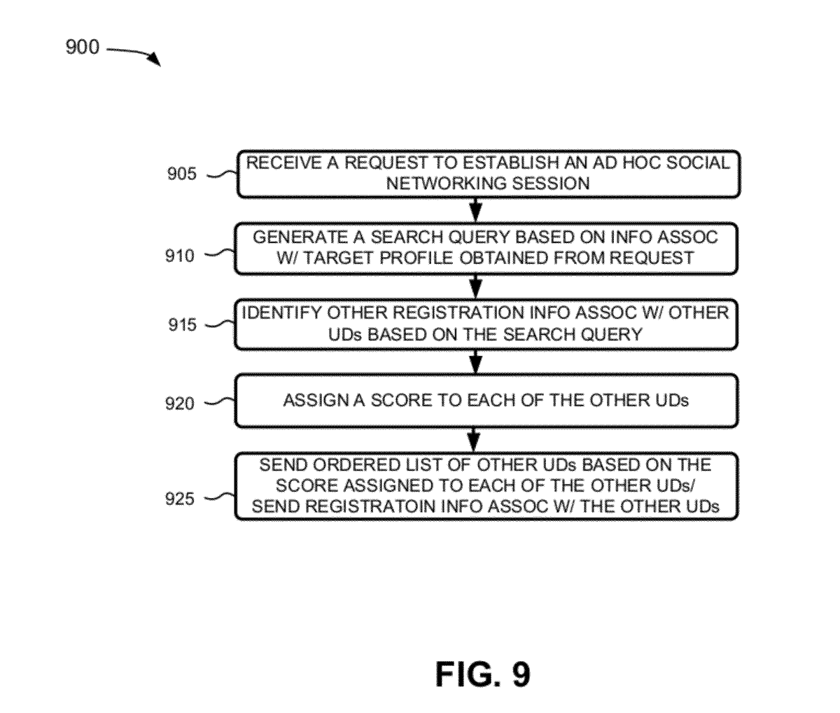

FIG. 9 is a flow chart of an example process for performing an ad hoc social networking operation to identify a list of targets based on a target profile. In one example implementation, process 900 may be performed by application server 120. In another example implementation, some or all of process 900 may be performed by a device or collection of devices separate from, or in combination with, application server 120.

As shown in FIG. 9, process 900 may include receiving a request to establish an ad hoc social networking session (block 905) and generating a search query based on information associated with a target profile obtained from the request (block 910). For example, application server 120 may receive, from an ad hoc application that is hosted by user device 110, a request to establish an ad hoc social networking session associated with user device 110. The request may include information associated with a target profile in a manner similar to that described above with respect to FIGS. 7A-7C.

Application server 120 may receive the request and may generate a search query to identify other user devices 110 to be included in the ad hoc social networking session. The search query may include search criteria that correspond to the information associated with the target profile. In one example, one search criterion may include all or a portion of information associated with position information (e.g., position information field 765 of FIG. 7C) obtained from the target profile. In another example, another search criterion may include all or a portion of information associated with candidate requirements (e.g., candidate requirements field 770 of FIG. 7C) obtained from the target profile. In yet another example, a further search criterion may include all or a portion of information associated with other criteria (e.g., other criteria field 775 of FIG. 7C) obtained from the target profile. In a further example, the search query may be generated based on information associated with a target profile that corresponds to a target companion profile, a target job profile, and/or another target profile.

As also shown in FIG. 9, process 900 may include identifying registration information associated with other user devices based on the search query (block 915). For example, application server 120 may use the search query to identify registration information, associated with other user devices 110, that matches at least one of the search criteria that are included in the search query. Application server 120 may generate a list of the other user devices 110.

As further shown in FIG. 9, process 900 may include assigning a score to each of the other user devices (block 920). For example, application server 120 may assign a respective score to each of the other user devices 110 based on a degree to which the registration information matches the search criteria included within the search query. For example, application server 120 may determine whether registration information, associated with another user device 110, matches one of the criteria within the search query. Application server 120 may assign a value (e.g., V1), to the other user device 110, based on the determination regarding whether the registration information matches one of the criterion. Application server 120 may, for example, assign a value (e.g., V1=1 or some other quantity) to the other user device 110 when the registration information matches one of the criterion. In another example, application server 120 may assign a different value (e.g. V1=0 or some different quantity) to the other user device 110 when the registration information does not match the criterion. Application server 120 may assign other values (e.g., V2, V3, etc.) to the other user device 110 for each of the other criteria, within the search query, based on whether the registration information matches each of the other criteria. Application server 120 may generate a score (e.g., S) for the other user device 110 based on the values assigned to each of the criteria (e.g., where S=V1+V2+V3, etc.).

In another example implementation, weighting factors (e.g., W1, W2, W3, etc.) may be assigned to each of the criteria within the search query and/or may be used to generate the scores for each of the other user devices 110. In one example, the weighting factors may determine a respective portion of the score that is to be attributed to each of the criteria (such that, for example, W_{TOTAL}=W1+W2+W3+, etc., where W_{TOTAL} is approximately equal to 1 or 100 percent, and where W1, W2, W3, etc. are less than or equal to 1). The weighting factors may, in one example, be predetermined by application server 120. In another example, the weighting factors may be predetermined by the ad hoc application (e.g., hosted by user device 110) and may be transmitted to application server 120 as part of the information associated with the target profile. In yet another example, a user, of user device 110, may specify the weighting factors while setting up the target profile and user device 110 may transmit the weighting factors to application server 120 as part of the information associated with the target profile. Application server 120 may generate a score (e.g., S) for the other user device 110 based on the values and/or weighting factors assigned to each of criteria (e.g., where S=V1*W1+V2*W2+V3*W3, etc.). Application server 120 may generate a respective score for each of the other user devices 110 based on the respective values assigned to each of the other user devices 110 and/or weighting factors associated with the criteria.

In yet another example implementation, application server 120 may perform an operation to determine whether any users, of other user devices 110, are planning to attend a function and/or to identify a sentiment among the users with respect to the function. For example, application server 120 may monitor traffic associated with the other user devices 110 that are communicating with a social networking website (e.g., associated with web server 130). The social networking website may be identified within the information associated with the target profile received from user device 110. In one example, the target profile may be associated with a target companion profile (e.g., target companion profile UI 700 of Fig. A) that identifies the function (e.g., a sporting event, a party, a business function, etc.) and/or an establishment (e.g., a restaurant, a night club, a sporting arena, etc.) at which the function is to occur during a period of time.

Application server 120 may detect whether any of the other user devices 110 may be located at the establishment to attend the function based on the traffic monitoring. For example, application server 120 may, based on the traffic monitoring, identify words and/or phrases that indicate that users associated with one of the other user devices 110 may be located at the establishment (such as, for example, “I'm going to the game . . . ,” “I'll see you at the happy hour . . . ,” “I've got tickets to the convention hall . . . ,” etc.). In another example, application server 120 may, based on the traffic monitoring, identify words and/or phrases that indicate that users associated with one of the other user devices 110 may not be located at the establishment (such as, for example, “I'm not going to the game . . . ,” “I'm working late . . . and will miss the happy hour . . . ,” “I don't have tickets . . . ,” etc.). Application server 120 may, based on the words and/or phrases, identify which of the other user devices 110 will be at the establishment and/or may identify a quantity of the other user devices 110 that will be located at the establishment.

Application server 120 may identify a sentiment or mood associated with users of the other user devices 110 that are communicating about the function and/or planning to attend the function. For example, application server 120 may, based on the traffic monitoring, identify a quantity of words or phrases that match key words or phrases (e.g., stored in a memory associated with application server 120) that correspond to a positive sentiment (e.g., “happy,” “excited,” “it'll be a great time,” “good time,” “I'm looking forward to . . . ” etc.). In another example, application server 120 may, based on the traffic monitoring, identify a quantity of words or phrases that match other key words or phrases (e.g., stored in the memory) that correspond to a negative sentiment (e.g., “boring,” “not excited,” “it won't be a great time,” “bad time,” “I'm not looking forward to . . . ” etc.). Application 120 may compare the quantity of words and/or phrase associated with positive sentiments to another quantity of words or phrases associated with negative sentiments to determine a measure of sentiment associated with the function and/or establishment. Application server 120 may, in one example, identify a positive level of sentiment with respect to the function or establishment when the quantity of words and/or phrases is greater than the other quantity of words or phrases by an amount that is greater than a threshold. Application server 120 may, in another example, identify a negative level of sentiment, with respect to the function and/or establishment, when the quantity of words and/or phrases is less than the other quantity of words or phrase may another amount that is greater than another threshold. Application server 120 may, in a further example, identify a neutral level of sentiment, with respect to the function and/or establishment, when the quantity of words and/or phrases is neither greater than nor less than the other words or phrase by the amount or the other amount, respectively.

As yet further shown in FIG. 9, process 900 may include sending an ordered list of other user devices based on the score assigned to each of the other user devices and sending registration information, associated with the other user devices (block 925). For example, application server 120 may rank the list of identifiers, corresponding to the other user devices 110, based on the scores assigned to the other user devices 110. In one example, one of the other user devices 110 with the highest score may be associated with a particular ranking (e.g., first). In this example, the highest ranking may indicate that the registration information, associated with one of the other user devices 110, matched more criteria, and/or or criteria associated with higher weighting factors, within the search query than the rest of the other user devices 110. In contrast, the lowest ranking (e.g., corresponding to the lowest score) may indicate that the registration information, associated with another one of the other user devices 110, did not match more criteria, and/or or criteria associated with higher weighting factors, within the search query than the rest of the other user devices 110.

Application server 120 may transmit, to user device 110, an ordered list of identifiers, associated with the other user devices 110, based on the rankings. Additionally, or alternatively, application server 120 may send, to user device 110, registration information associated with the other user devices 110. In another example implementation, application server 120 may transmit, to user device 110, information associated with a measure of sentiment, associated with other user devices 110, with respect to a function and/or establishment at which user device 110 may be located. Application server 120 may transmit information that identifies which of the other user devices 110 and/or a quantity of the other user devices 110 that may be located at the establishment.

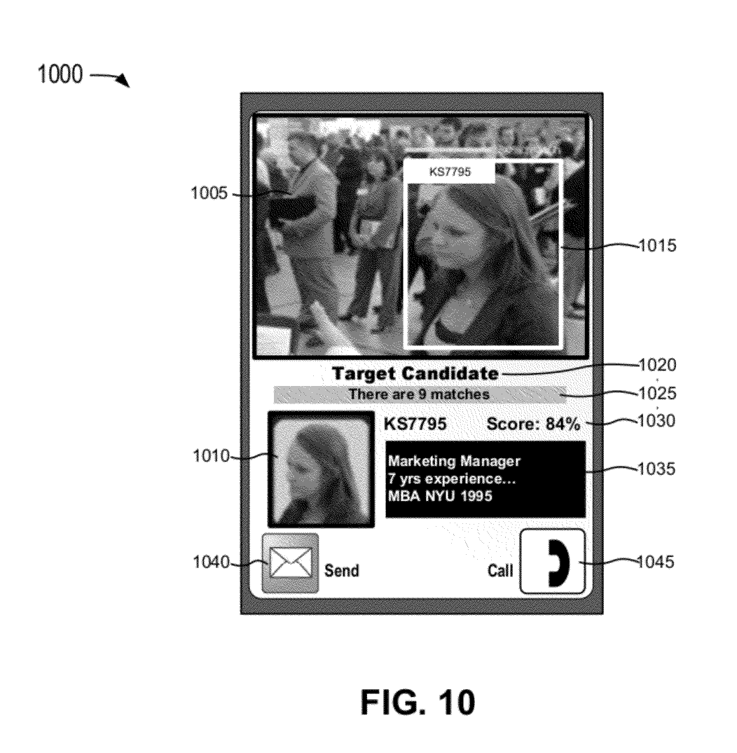

FIG. 10 is an example diagram of a target UI 1000 according to an implementation described herein. Target UI 1000 may be presented on user device 110, by an ad hoc application as a result of an ad hoc social networking operation. As shown in FIG. 10, target UI 1000 may include a collection of fields, and/or buttons, such as a camera display field 1005, a target identification (ID) window field 1010, a target image field 1015, a target profile field 1020, a target list field 1025, a target score field 1030, a target description field 1035, a message button 1040, and a call button 1045. Target UI 1000 includes fields and/or buttons 1005-1045 for explanatory purposes. In practice, target UI 1000 may include additional fields and/or buttons, fewer fields and/or buttons, different fields and/or buttons, and/or differently arranged fields and/or buttons than are described with respect to target UI 1000.

Camera display field 1005 may include an image and/or video content, obtained from a camera associated with user device 110. Target image field 1010 may include an image of a user, associated with another user device 110, that has been identified as a target user in a manner similar to that described above with respect to FIG. 9. The ad hoc application may retrieve information, associated with the image of the target user, from the registration information received from application server 120 as a result of an ad hoc social networking operation. Target ID window field 1015 may be enable the target user, associated with the other user device 110, to be selected within the image and/or video content included within camera display field 1005. The target user may be selected by the ad hoc application when information associated with the target user (e.g., such as the image of the user) matches all or a portion of the image and/or the video content included within camera display field 1005. Target ID window field 1015 may, for example, include a target identifier (e.g., KS7795) that corresponds to the target user and which is obtained from the registration information. The ad hoc application may use facial recognition techniques, visual signatures, etc. to determine whether the image of the target user matches all or the portion of the image and/or video content.

Target profile field 1020 may include information associated with a target profile that was used by the ad hoc application and/or application server 120 to perform an ad hoc social networking operation. For example, target profile field 1020 may include information associated with a particular target profile (e.g., a target candidate profile obtained via target candidate profile UI 760 of FIG. 7C). Target list field 1025 may include information associated with a quantity of targets, associated with other user devices 110, that were included in a list of targets received from application server 120 as a result of the ad hoc social networking operation. For example, target list field 1025 may include a quantity of target identifiers and the ad hoc application may cause the quantity of target identifiers (e.g., there are 9 matches) to be displayed via target list field 1025. Target score field 1030 may include a target identifier and/or a value associated with a score that was assigned to the target identifier. For example, the target user may be associated with a target identifier (e.g., KS7795) and/or a score (e.g., 84%) and the ad hoc application may cause the target identifier and/or the score to be displayed via target score field 1030. Target description field 1035 may include information associated with a user, which corresponds to the selected target, based on registration information associated with the target user. The ad hoc application may cause the information associated with the target user (e.g., marketing manager, 7 yrs experience . . . , MBA, NYU 1995) to be displayed via target description field 1035.

Message button 1040 may permit a user, of user device 110, to communicate with the selected user. For example, the user, of user device 110, may select message button 1040 (e.g., shown as a icon of an envelope with a send label), which may cause the ad hoc application to open a message UI via which text, associated with a message (e.g., an email message, an instant message, etc.), may be received from the user of user device 110. The ad hoc application may cause the message to be transmitted to the other user device 110 with which the target user is associated. Call button 1045 may permit the user, of user device 110, to place a call to the other user device when the user selects call button 1045 (e.g., shown as an icon of a telephone receiver with a call label).

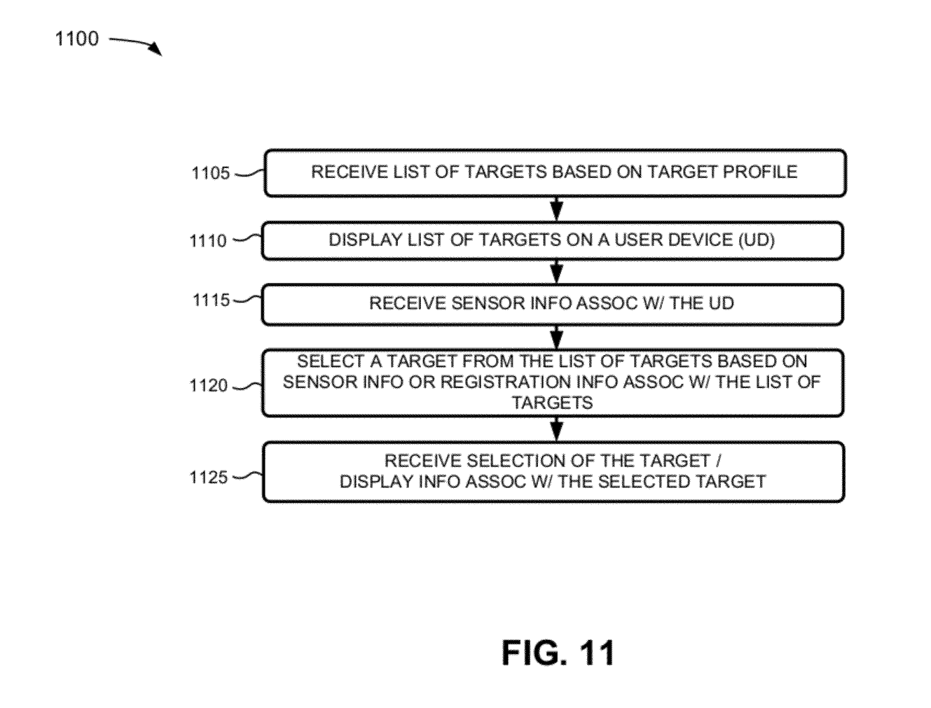

FIG. 11 is a flow chart of an example process 1100 for selecting a target user as a result of an ad hoc social networking operation. In one example implementation, process 1100 may be performed by user device 110. In another example implementation, some or all of process 1100 may be performed by a device or collection of devices separate from, or in combination with, user device 110.

As shown in FIG. 11, process 1100 may include receiving an ordered list of targets based on a target profile (block 1105) and displaying the list of targets on a user device (block 1110). For example, user device 110 may receive an ordered list of target identifiers (e.g., names, ID numbers, etc.) that correspond to users, associated with other user devices 110. The users, associated with the other user devices 110, may be have been identified as a result of an ad hoc social networking operation that was performed, by application server 120, at an earlier point in time in response to information associated with a target profile that was sent by user device 110. The ordered list of target identifiers may include a respective score, assigned by application server 120, that correspond to each of the target identifiers. The ordered list of target identifiers may also, or alternatively, include other registration information associated with each of the other user devices 110 that was used, by application server 120, to identify the other user devices 110. The ad hoc application may cause the list of identifiers and/or the respective scores to be displayed on user device 110.

In another example implementation, user device 110 may receive information associated with a sentiment, that corresponds to the users associated with the other user devices 110, in a manner similar to that described above with respect to FIG. 9. The sentiment may be associated with a function to be held at an establishment (e.g., as indicated in the information associated with the target profile, obtained via target companion profile UI 700 of FIG. 7A). Additionally, or alternatively, user device 110 may receive information associated with each of the other user devices 110 and/or a quantity of the other user devices 110 that are attending or may attend the function at the establishment. The ad hoc application may cause the information associated with the sentiment to be displayed on user device 110. The ad hoc application may cause an indication associated with each of the other user devices 110 and/or the information associated with the quantity of other user devices 110 to be displayed on user device 110. Displaying the information associated with the sentiment and/or the quantity of other user devices 110 may assist a user, of user device 110, to decide whether to attend the function at the establishment.

As also shown in FIG. 11, process 1100 may include receiving sensor information associated with the user device (block 115). For example, the user, of user device 110, may view the list of the other user devices 110 on user device 110 and may use user device 110 to collect sensor information, associated with an environment in which user device 110 is located, to assist the user, of user device 110, to select a target from the list of targets. The user may, for example, collect one or more images of the environment by using user device 110 (e.g., via camera 340 of FIG. 3) to take pictures of an environment in which user device 110 is located (such as, for example, a room within a residence and/or business, a sports arena, a job fair, etc.). In another example, the user may collect video content of the environment by using user device 110 to obtain a video recording of the environment. In another example implementation, user device 110 may receive, from application server 120, information associated with locations of the other user devices 110 within the environment. The information associated with the locations may be based on information associated with GPS locations of the other user devices 110 obtained, by application server 120, from the other user devices 110. User device 110 may map the information associated with the GPS locations on a floor plan and/or map, associated with the environment, that permits the user, of user device 110, to identify one or more users associated with the other user devices 110.

As further shown in FIG. 11, process 1100 may include selecting a target based on the sensor information or registration information associated with the list of targets (block 1120). For example, the ad hoc application may compare images, associated with users of the other user devices 110, to the one or more images of the environment and/or the video content of the environment. The ad hoc application may identify a user, of one of the other user device 110, associated with an image that matches any of the one or more images of the environment and/or all or a portion of the video content of the environment. The ad hoc application may select a target identifier that corresponds to the identified user.

In another example implementation, the user may select a target identifier, from the list of target identifiers. In one example, the selection may be based on a score associated with the selected target identifier. In another example, the selection may be based on an indication that a user, of one or the other user devices 110, that corresponds to the selected target identifier is located, or may be located at the establishment. The user, of user device 110, may select the target identifier in a manner that does not include collecting sensor information associated with the image and/or video content.

As still further shown in FIG. 11, process 1100 may include receiving selection of a target and displaying information associated with the selected target (block 1125). For example, user device 110 may receive, from the user of user device 110, selection of a target with which the user desires to communicate. In one example implementation, user device 110 may receive the selection via the target UI when the user selects a particular button (e.g., message button 1040 or call button 1045 of FIG. 10), within the target UI, that causes user device 110 to communicate with one of the other user devices 110 with which the identified user is associated.

In another example, user device 110 may receive, from the user of user device 110, selection of the target identifier, from the list of target identifiers. The ad hoc application may retrieve, from a memory associated with user device 110, registration information associated with a user, of one of the other user devices 110, that correspond to the selected target identifiers. The ad hoc application may display all or a portion of the registration information on user device 110 (e.g., via target UI 1000 of FIG. 10). Displaying the registration information, via the target UI, may permit the user, of user device 110, to communicate with the user, of one of the other user devices 110 (e.g., when the user presses the particular button).

Systems and/or methods, described herein, may enable an ad hoc social networking operation to be performed, with other user devices, based a target profile established by a user of a user device. The systems and/or methods may use the target profile to identify other users, of the other user devices, based on whether registration information, associated with the other user devices, matches one or more criteria included within the target profile. The systems and/or methods may assign a respective score to each of the other user devices based on a degree to which the registration information matches the one or more criteria included within the target profile. The systems and/or methods may generate an ordered list of identifiers that corresponds to the other users and/or other user devices based on the assigned score.

The systems and/or methods may select, from the list, an identified user with which to communicate. In another example, the systems and/or methods may scan an environment, at which one or more of the other user devices are located, to obtain information (e.g., audio, images, video, visual signatures, etc.) associated with the environment. The systems and/or methods may identify another user with which to communicate when registration information associated with the other user, matches a portion of the information associated with the environment.

The foregoing description provides illustration and description, but is not intended to be exhaustive or to limit the implementations to the precise form disclosed. Modifications and variations are possible in light of the above teachings or may be acquired from practice of the embodiments.

While series of blocks have been described with regard to FIGS. 6, 8, 9, and 11, the order of the blocks may be modified in other implementations. Further, non-dependent blocks may be performed in parallel.

It will be apparent that systems and methods, as described above, may be implemented in many different forms of software, firmware, and hardware in the implementations illustrated in the figures. The actual software code or specialized control hardware used to implement these systems and methods is not limiting of the implementations. Thus, the operation and behavior of the systems and methods were described without reference to the specific software code—it being understood that software and control hardware can be designed to implement the systems and methods based on the description herein.

Further, certain portions, described above, may be implemented as a component or logic that performs one or more functions. A component or logic, as used herein, may include hardware, such as a processor, an ASIC, or a FPGA, or a combination of hardware and software (e.g., a processor executing software).

It should be emphasized that the terms comprises and comprising, when used in this specification, are taken to specify the presence of stated features, integers, steps or components but do not preclude the presence or addition of one or more other features, integers, steps, components or groups thereof.

Even though particular combinations of features are recited in the claims and/or disclosed in the specification, these combinations are not intended to limit the disclosure of the embodiments. In fact, many of these features may be combined in ways not specifically recited in the claims and/or disclosed in the specification. Although each dependent claim listed below may directly depend on only one other claim, the disclosure of the embodiments includes each dependent claim in combination with every other claim in the claim set.

No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
receiving, by a user device, information associated with a target profile on which to perform an ad hoc social networking operation, where the information, associated with the target profile, includes one or more criteria that:
identify characteristics that a user, of the user device, desires in another user associated with another user device, and
identify a location at which the other user device is to be located;
transmitting, by the user device and to a server device, the information associated with the target profile;
receiving, by the user device and from the server device, a list of one or more user devices that are identified based on the one or more criteria, where the list of the one or more user devices includes information relating to each of one or more users associated with the one or more user devices;
obtaining, by the user device, information associated with at least one of the one or more users, associated with at least one of the one or more user devices that are located at the location;
selecting, by the user device, a particular user device, of the at least one of the one or more user devices, based on a determination that the information matches other information relating to a particular user, of the one or more users, where the particular user is associated with the particular user device; and
communicating, by the user device and with the particular user device, based on the selection of the particular user device.

2. The method of claim 1, further comprising:
receiving a request to set up the target profile;
presenting for display, on the user device and in response to the request, a target profile user interface that permits the user to enter the information associated with the target profile; and
receiving the information, associated with the target profile, via the target profile user interface.

3. The method of claim 1, where the information associated with the target profile includes at least one of:
information associated with a gender of the other user,
information associated with a race or ethnicity of the other user,
information associated with physical features of the other user,
information associated with a religious affiliation of the other user,
information associated with an education level of the other user, or
information associated with an interest or hobby of the other user.

4. The method of claim 1, where the information associated with the target profile includes at least one of:
information associated with a job opening to be filled by the other user,
information associated with requirements of the job opening, the requirements including at least one of:
information associated with years of experience of the other user,
information associated with an education level of the other user, or
information associated with a career level of the other user.

5. The method of claim 1, where transmitting the information associated with the target profile enables:
the one or more user devices to be identified based on a determination that the information relating to each of the one or more users matches at least one of the one or more criteria, and
the list of the one or more user devices to be generated based on the identification of the one or more user devices.

6. The method of claim 1, further comprising:
receiving, from the user, a selection of a further user device, from the list of the one or more user devices;
retrieving particular information associated with a further user, of the one or more users, that corresponds to the further user device;
displaying, on the user device and via a user interface, the particular information associated with the further user; and
receiving, via the user interface, an instruction to communicate with the further user device based on the particular information associated with the further user.

7. The method of claim 1, where the list of the one or more user devices includes one or more scores that correspond to the one or more user devices,
where the one or more scores are based on a degree to which information associated with the one or more users matches the one or more criteria, and
where the method further comprises:
receiving, from the user, a selection of a further user device, from the list of one or more user devices, based on a score, of the one or more scores, that corresponds to the further user device;
retrieving particular information associated with a further user, of the one or more users, that corresponds to the further user device; and
presenting, for display on the user device, the particular information associated with the further user.

8. The method of claim 1, where obtaining the information includes:
recording, via a camera associated with the user device, the at least one of the one or more users, that are located at the location, to obtain a video signal; and
processing the video signal to obtain the information.

9. The method of claim 1, where selecting the particular user device further includes:
obtaining, from the information associated with the particular user, an image of the particular user;
comparing the image of the particular user to the information associated with the at least one of the one or more users, where the information, associated with the at least one of the one or more users, includes video information, of the at least one of the one or more users, obtained via a camera associated with the user device; and
determining that the image of the particular user matches all or a portion the video information.

10. A server device comprising:
a memory to store registration information associated with a plurality of user devices, where registration information associated with a particular user device, of the plurality of user devices, includes at least one of:
information associated with a particular user of the particular user device,
information associated an affiliation with which the particular user is associated, or
information associated with professional credentials of the particular user; and one or more processors to:
receive, from a user device, of the plurality of user devices, a request to identify at least one of the plurality of user devices with which to communicate based on one or more criteria,
identify one or more user devices, of the plurality of user devices, based on a determination that registration information, associated with the one or more user devices, matches at least one of the one or more criteria,
assign a respective score to each of the one or more user devices based on a respective quantity, of the one or more criteria, that is matched by respective registration information, associated with each of the one or more user devices, and
transmit, to the user device, a list of the one or more user devices, the respective scores assigned to each of the one or more user devices, where transmitting the list of the one or more user devices enables the user device to select any of the one or more user devices, with which to communicate, based on the respective scores.

11. The server device of claim 10, where the one or more criteria identify characteristics that a user, of the user device, desires in another one or more users of the one or more user devices.

12. The server device of claim 10, where the one or more criteria:
identify a location at which a user, of the user device, specifies that the one or more user devices are to be located, and
where transmitting the list of the one or more user devices enables the user device to:
obtain video information associated with at least one user, of one or more users associated with the one or more user devices that are located at the location, and
select the at least one user when the video information matches registration information associated with the at least one user.

13. The server device of claim 10, where the one or more processors are further to:
rank one or more user devices, of the list of the one or more user devices, to create a ranked list of the one or more user devices, where the ranked list of the one or more user devices is based on one or more other scores that correspond to the one or more user devices, and
transmit, to the user device, the ranked list of the one or more user devices, where the ranked list enables the user device to display one of the one or more user devices that is ranked higher than any other of the one more user devices.

14. The server device of claim 13, where, when ranking the one or more user devices to create the ranked list of the one or more user devices, the one or more processors are to:
identify a first score, associated with a first user device of the one or more user devices, based on a first quantity of the one or more criteria that matches registration information associated with the first user device,
identify a second score, associated with a second user device of the one or more user devices, based on a second quantity, of the one or more criteria, that is matches registration information associated with the second user device, and
rank the first user device higher than the second user device when the first score is greater than the second score.

15. The server device of claim 10, where the one or more processors are further to:
monitor communications between the one or more user devices and a web server, associated with a social networking website, to obtain a measure of sentiment, among one or more users of the one or more user devices, relating to an event that is to be held at a location,
identify a positive measure of sentiment when a quantity of terms, associated with a positive measure of sentiment, that are used in the communications is greater than another quantity of other terms, associated with a negative measure of sentiment, that are used in the communications,
identify a negative measure of sentiment when the quantity of terms, associated with the positive measure of sentiment, is not greater than the quantity of other terms, associated with the negative measure of sentiment, and
transmit, to the user device, an indication of whether there is a positive measure of sentiment associated with the event or a negative measure of sentiment, associated with the event, based on monitoring the communications, where the indication that there is the positive measure of sentiment or the negative measure of sentiment enables a user, of the user device, to determine whether the user device is to located at the location.

16. The server device of claim 10, where the one or more processors are further to:
monitor communications between the one or more user devices and a web server, associated with a social networking website, to identify a quantity, of the one or more user devices, that are to be located at a location, and
transmit, to the user device, the quantity of the one or more user devices that are to be located at the location.

17. A non-transitory computer-readable medium containing one or more instructions executable by one or more processors, the computer-readable medium comprising:
one or more instruction to receive information associated with one or more criteria to be used to identify a particular user device with which to establish an ad hoc social networking session, where the one or more criteria:
identify characteristics that are to be associated with a user, of the particular user device, and
identify a location at which the user device is to be located;
one or more instructions to transmit, to a server device, the information associated with the one or more criteria;
one or more instructions to receive, from the server device, a list of one or more user devices and one or more scores corresponding to the one or more user devices, identified in the list of user devices, where each score, of the one or more scores, identifies a relative quantity, of the one or more criteria, that is matched by respective information associated with characteristics of each user, of one or more users, associated with the one or more user devices;
one or more instructions to select a user device, of the list of one or more user devices, that corresponds to a score, of the one or more scores, that is greater than any other score, of the one or more scores; and
one or more instructions to transmit a message to the user device to establish the ad hoc social networking session with the user device based on the selection of the user device.

18. The non-transitory computer readable medium of claim 17, where the one or more instructions to receive the list of user devices and the one or more scores, further include:
one or more instructions to receive the respective information associated with the characteristics of each user, where the respective information associated with the characteristics of each user includes at least one of:
information associated with respective physical characteristics of each user,
information associated with respective professional credentials of each user, or
information associated respective affiliations with which each user is associated.

19. The non-transitory computer-readable medium of claim 17, further comprising:
one or more instructions to obtain one or more images of at least one other user, of the one or more users, associated with another user device, of the one or more user devices, that is located at the location; and
one or more instructions to select the other user device based on a determination that at least one of the one or more images matches an image of the other user obtained from information associated with characteristics of the other user.

20. The non-transitory computer readable medium of claim 17, further comprising:
one or more instructions to receive, from the server device, information associated with a quantity of the one or more user devices that are to be located at the location,
where the information associated with the quantity of the one or more user devices that are to be located at the location is based on monitoring communications between the one or more user devices and a web server associated with a social networking website.

21. The non-transitory computer readable medium of claim 17, further comprising:
one or more instructions to receive, from the server device, information associated with a measure of sentiment, among one or more users of the one or more user devices, associated with an event to be held at the location,
where a positive measure of sentiment exists when a quantity of terms, associated with a positive measure of sentiment, that are used in communications between the one or more user devices and a web server associated with a social networking website is greater than a quantity of other terms, associated with a negative measure of sentiment, that are used in the communications, and
where the negative measure of sentiment exists when the quantity of terms, associated with the positive measure of sentiment is not greater than the quantity of other terms, associated with the negative measure of sentiment; and
one or more instructions to establish the ad hoc networking session at the location when the measure of sentiment is a positive measure of sentiment.

22. The non-transitory computer readable medium of claim 17, further comprising:
one or more instructions to receive, from the server device, an ordered list of another one or more user devices, where the ordered list of the other one or more user devices is based on another one or more scores corresponding to the other one or more user devices
one or more instructions to select another user device, of the ordered list of the other one or more user devices, where the other user device is located at the beginning of the ordered list of the other user devices; and
one or more instructions to transmit another message to the other user device to establish another ad hoc social networking session with the other user device based on the selection of the other user device.
